(19) United States
(12) Patent Application Publication
(10) Pub. No.: US 2011/0310616 A1
(43) Pub. Date: Dec. 22, 2011

(54) LUMINAIRE

(76) Inventor: John Carruthers, San Clemente, CA (US)

(21) Appl. No.: 12/816,517

(22) Filed: Jun. 16, 2010

(51) Int. Cl. F21V 7/07; F21V 5/04; F21V 7/00; F21V 5/00

(52) U.S. Cl. 362/296.05; 362/311.01; 362/311.06; 362/311.02; 362/296.01

(57) ABSTRACT

A luminaire includes a planar light guide having a substrate with a back surface, a light emitting surface, and an edge therebetween with a light source disposed at the edge for emitting light thereinto. A geometric structure on the light guide provides for directing light entering the light guide edge outwardly from the light-emitting surface. The luminaire may be utilized for retrofitting of existing canned lighting or in flush mount applications.

Generally speaking, downlights refer to ceiling mounted lighting fixtures for illumination therebelow.

Such luminaries heretofore have included an incandescent, halogen, or CFL light source mounted within a can-like structure. Existing downlights typically have cans with 3 inch or 4-inch diameters and it is desirable to replace existing incandescent, halogen, or CFL light sources utilized in existing cans with light emitting diodes (LEDs) as well as provide for new downlight fixtures utilizing LEDs which have up to 80% greater efficiency than traditional incandescent lamps, up to 27% more efficiency than compact florescent lamps (CFL's), that may contain toxic mercury. LED's have a longer life span, lower maintenance costs, lower greenhouse gas emissions, and a lower total cost of ownership than traditional light sources. In addition, LEDs have less hazardous waste disposal resulting in less polluted environment, emit significantly less heat into the environment resulting in improved operating costs. Further, the use of multi-colored LEDs enables any shade or hue in the spectrum to be created.

In accordance with the present invention, a luminaire is provided which is not only suitable for retrofit for existing downlight cans, but also for installations in which space requirements make the use of downlight cans impossible. The reduced thickness of the luminaire in accordance with the present invention provides for essentially flat fixture lighting for existing ceiling surfaces.

### SUMMARY OF THE INVENTION

A luminaire in accordance with the present invention generally includes a planer light guide having a substrate with an edge and a light-emitting surface. A geometric structure is provided on the light-emitting surface for directing light entering the light guide edge downwardly from the light-emitting surface. This structure provides for luminaire thickness of less than 1-inch.

Preferably, the geometric structure may be an array of nanostructures and include prisms embossed onto the light-emitting surface or alternatively formed on light shading diffusers adhered to the light-emitting surface. For a circular light guide, the prisms may be disposed along radii of the guide and each prism has a proximal depth, nearer the light guide center, smaller than a distal depth farther from the light guide center.

A reflector may be disposed on a side of the substrate opposite the light emitting surface and a plurality of spaced apart light emitting diodes disposed at the substrate edge for emitting light thereinto may be used as a light source.

When the luminaire is designed for retrofit to existing can structures, a circular shape is preferable.

### BRIEF DESCRIPTION OF THE DRAWINGS

The present invention may be more clearly understood with reference to the following detailed description in connection with the appended drawings, in which:

FIG. 1 is a side view of the present invention as it may be flush mounted to a ceiling;

FIG. 2 is a plan view taken along the line 2-2 of FIG. 1, of the luminaire in accordance with the present invention illustrating a light-emitting surface with oriented nanostructure along with a light shield encircling a perimeter of the planar light guide;

FIG. 3 is a perspective view of the prism nano-structure and an illustration of light passing through; and

FIG. 4 is another perspective view similar to FIG. 3 illustrating dimensions of the prism.

### DETAILED DESCRIPTION

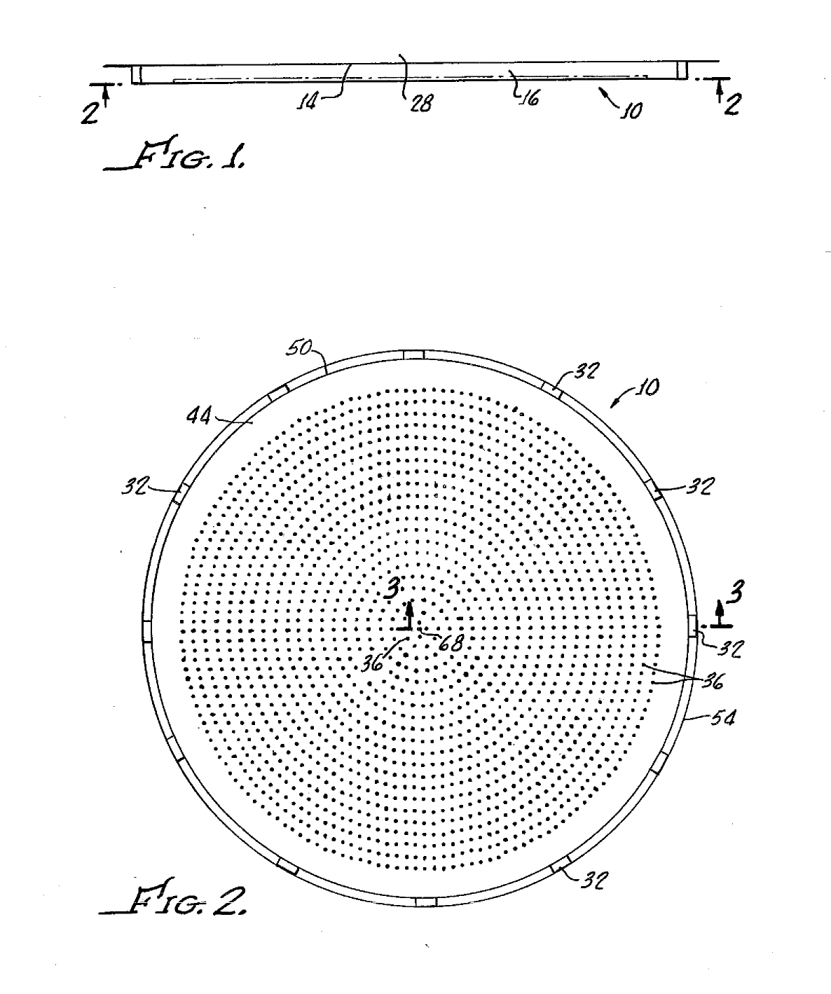

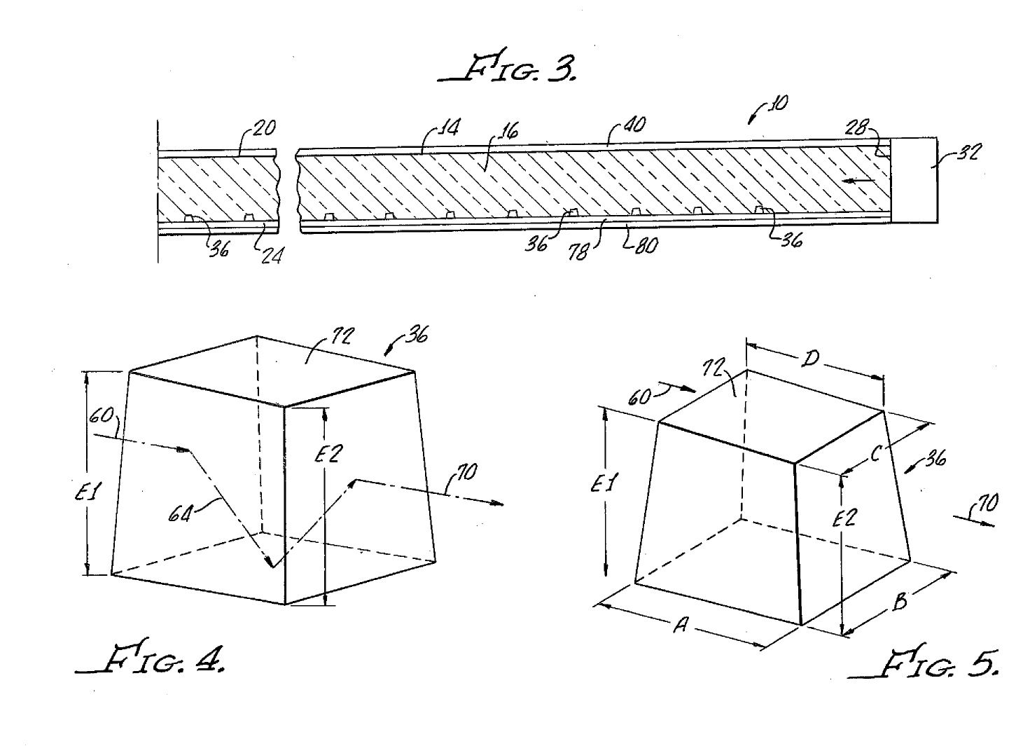

With reference to FIGS. 1-3, there is shown a luminaire 10 in accordance with the present invention, which generally includes a planar light guide 14, best shown in FIG. 3, that includes a substrate 16, a back surface 20, a light emitting surface 24 along with the edge 26 extending between the back surface 20 and light emitting surface 24.

The light guide 14 may be formed from a poly (methacrylate) or MMA and is preferably circular and with a 3-inch or 4-inch diameter, the guide will fit exactly into existing canned lighting openings that currently use incandescent halogen, or compound fluorescent lamps (CFLs). Other suitable materials may be utilized. Alternatively, as shown in FIG. 1, the luminaire 10 may be flush mounted on a ceiling 28, or the like, and can use existing wiring when available, such as in existing canned lighting receptacles.

As best shown in FIGS. 2 and 3, a plurality of side emitting diodes such as, for example, diodes NSSMO38AT available from Nichia Corporation of Tokushima, Japan may be disposed in a spaced apart manner along the light guide edge 26 for emitting light into the light guide 14. Other source of light may also be utilized.

A geometric structure such as a plurality of nano-structures in the form of prisms 36 may be embossed into the light emitting surface 24 along radii of the light guide 14 as shown in FIG. 2 and a lambertian coating reflector 40 is provided on the back surface 20 of the substrate 16 as best shown in FIG. 3. Such embossed light guides 14 are available from Luminit LLC, Torrance, Calif.

As shown in FIG. 2, a light shield 44 may be provided around a periphery 50 of the light guide 14. Preferably, the light guide 14 is a circular typical 3-inch and 4-inch diameters, as hereinabove noted for retrofitting into existing lighting cans, not shown.

Edge reflectors 54 may be disposed at the substrate edge 26 between the diodes 32 in order to increase the efficiency of the luminaire 10. With reference to FIGS. 4 and 5, detail of the embossed prisms 36 are set forth, with the dimensions of the embossed prisms not to scale but rather enlarged in order to illustrate their configuration. Each of the prisms have base dimensions A and B of about 0.050 mm and top dimensions C and D of about 0.042 mm. The spacing between the prisms on radii is shown in FIG. 2 are about 0.005 mm, the spacing shown in FIG. 2 not being to scale.

As shown in FIG. 4, light from the diode 32 entering through the edge 26 as illustrated by arrow 60 in FIG. 4 passes through the prisms and is partially transmitted orthogonally by each of the prisms 36, as illustrated by the pattern 64 with the light going toward a center 68 of the light guide (see FIG. 2) as illustrated by the arrow 70.

Importantly, each of the prisms 36 has an embedded top surface 72 sloping toward the center 68 of the light guide 14. For example, with the embossing 36 having the dimensions hereinabove set forth, each of the prisms 36 has a proximal depth E1 near the light guide center 68 than a distal depth E2 farther from the light guide center 68 with the depths E1 and E2 being about 0.0050 mm and 0.0052 mm respectively.

Referring again to FIG. 3, at least one light shaping diffuser (LSD) 78, 80 may be disposed on the light emitting surface 24 over the embossed prisms 36. Such light shaping diffusers are also available from Luminit and provide for 85% to 92% transmission with such films providing additional uniformity to the emitted light.

Although there has been hereinabove described a specific LED downlight in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. A luminaire comprising:
a planer light guide having a substrate with a back surface, a light emitting surface and an edge therebetween;
a geometric structure on the light guide for directing light, entering the light guide edge, outwardly from the light emitting surface; and
a light source disposed at the substrate edge for emitting light thereinto.

2. The luminaire according to claim 1 wherein said planer light guide is circular.

3. The luminaire according to claim 1 further comprising a reflector disposed on the light side back surface.

4. The luminaire according to claim 3 wherein the light side back surface is smooth.

5. The luminaire according to claim 1 wherein the geometric structure is comprised of an array of nanostructures.

6. The luminaire according to claim 5 wherein the nano-structures are embossed on the light-emitting surface.

7. The luminaire according to claim 6 wherein the nano-structures comprise prisms.

8. The luminaire according to claim 7 wherein the prisms are Dove prisms.

9. The luminaire according to claim 8 wherein said prism are disposed along radii of the circular planer light guide.

10. The luminaire according to claim 9 wherein each prism has a proximal depth, nearer the light guide center, smaller than a distal depth, farther from the light guide center.

11. The luminaire according to claim 10 wherein the light source comprises a plurality of spaced apart light emitting diodes (LEDs) disposed at the substrate edge for emitting light thereinto.

12. The luminaire according to claim 11 further comprising an edge reflector disposed between the LEDs on the substrate edge.

13. The luminaire according to claim 1 further comprising a light shaping diffuser disposed on the light-emitting surface.

14. A luminaire comprising:
a planer light guide having a substrate with a back surface, a light emitting surface and an edge therebetween;
a geometric structure on the light guide for directing light, entering the light guide edge, outwardly from the light-emitting surface;
at least one light shaping diffuser disposed over the nano-structure;
a reflector disposed on a side of the light guide back surface; and
a light source disposed at the substrate edge for emitting light thereinto.

15. The luminaire according to claim 14 wherein said planer light guide is circular.

16. The luminaire according to claim 14 wherein the light guide side back surface is smooth.

17. The luminaire according to claim 14 wherein the geometric structure is comprised of an array of nanostructures.

18. The luminaire according to claim 17 wherein the nano-structures are embossed in the light-emitting surface.

19. The luminaire according to claim 18 wherein the nano-structures comprise prisms.

20. The luminaire according to claim 19 wherein the prisms are Dove prisms.

21. The luminaire according to claim 14 wherein the light source comprises a plurality of spaced apart light emitting diodes (LEDs) disposed at the substrate edge for emitting light thereinto.

22. The luminaire according to claim 21 further comprising an edge reflector disposed between the LEDs on the substrate edge.

23. The luminaire according to claim 22 wherein said prisms are disposed along radii of the circular planer light guide.

24. The luminaire according to claim 23 wherein each prism has a proximal depth, nearer the light guide center, smaller than a distal depth, farther from the light guide center.
